(19) United States
(12) Patent Application Publication
(10) Pub. No.: US 2022/0400312 A1
(43) Pub. Date: Dec. 15, 2022

(54) OPTIMIZATION DEVICE, OPTIMIZATION METHOD, AND RECORDING MEDIUM

(71) Applicant: NEC Corporation, Minato-ku, Tokyo (JP)

(72) Inventors: Yasuhisa SUZUKI, Tokyo (JP); Wemer WEE, Tokyo (JP)

(73) Assignee: NEC Corporation, Minato-ku, Tokyo (JP)

(21) Appl. No.: 17/776,706

(22) PCT Filed: Nov. 18, 2019
(86) PCT No.: PCT/JP2019/045044

§ 371 Date: May 13, 2022

(51) Int. Cl. H04N 21/458; H04N 21/466

(52) U.S. Cl. CPC H04N 21/458; H04N 21/4662

(57) ABSTRACT

An input of a constraint parameter associated with a constraint required when optimizing a target is received. An objective function to be utilized for the optimization of the target is computed by using optimized results by an expert who has performed the optimization in the past, the constraint parameter, and an inverse optimization technique. The target is optimized based on the objective function.

### TECHNICAL FIELD

The present invention relates to an optimization device, an optimization method, and a recording medium.

### BACKGROUND ART

Considerable labor is used to optimize optimization targets based on the characteristics thereof. As one example, considerable labor is used to optimally schedule scheduling targets, which are optimization targets, based on the characteristics and the like thereof. For example, scheduling targets include advertisement broadcasts. The work of deciding on dates and times of advertisement broadcasts and the television programs during which they are to be aired takes considerable labor for workers.

As related technology, Patent Document 1 discloses technology for preparing a television program schedule defining a temporal sequence of multiple contents distributed to a user in accordance with the user's preferences and circumstances.

### CITATION LIST

### Patent Literature

[Patent Document 1]
WO 2005/096629 A1

### SUMMARY OF THE INVENTION

### Problem to be Solved by the Invention

A system that can optimize optimization targets in accordance with the desires of a user by using an objective function newly reflecting the desires of the user in an objective function estimated by the above-mentioned inverse reinforcement learning is sought.

Therefore, an objective of the present invention is to provide an optimization device, an optimization method, and a recording medium that solve the above-mentioned problem.

### Means for Solving the Problem

An optimization device according to one aspect of the present invention is characterized by comprising a reception means for receiving an input of a constraint parameter associated with a constraint required when optimizing a target; an objective function computation means for computing an objective function to be utilized for the optimization of the target by using optimized results by an expert who has performed the optimization in the past, the constraint parameter, and an inverse optimization technique; and an optimization means for optimizing the target based on the objective function.

Additionally, an optimization method according to one aspect of the present invention is characterized by receiving an input of a constraint parameter associated with a constraint required when optimizing a target; computing an objective function to be utilized for the optimization of the target by using optimized results by an expert who has performed the optimization in the past, the constraint parameter, and an inverse optimization technique; and optimizing the target based on the objective function.

Additionally, a recording medium according to one aspect of the present invention is characterized by recording a program for making a computer in an optimization device function as a reception means for receiving an input of a constraint parameter associated with a constraint required when optimizing a target; an objective function computation means for computing an objective function to be utilized for the optimization of the target by using optimized results by an expert who has performed the optimization in the past, the constraint parameter, and an inverse optimization technique; and an optimization means for optimizing the target based on the objective function.

### Advantageous Effects of Invention

According to the present invention, an optimization target can be optimized in accordance with the desires of a user by using an objective function newly reflecting the desires of the user.

### BRIEF DESCRIPTION OF THE DRAWINGS

FIG. 1 is a diagram illustrating an overview of a scheduling system.

FIG. 2 is a diagram illustrating a hardware configuration of a scheduling device.

FIG. 3 is a functional block diagram of the scheduling device.

FIG. 4 is a first diagram illustrating the processing flow in a scheduling device according to the present embodiment.

FIG. 5 is a diagram illustrating a constraint correction check screen according to the present embodiment.

FIG. 6 is a second diagram illustrating the processing flow in the scheduling device according to the present embodiment.

FIG. 7 is a diagram illustrating a schedule correction screen according to the present embodiment.

FIG. 8 is a third diagram illustrating the processing flow in the scheduling device according to the present embodiment.

FIG. 9 is a diagram illustrating the minimum configuration of a scheduling device.

FIG. 10 is a diagram illustrating the processing flow in the scheduling device having the minimum configuration.

### EXAMPLE EMBODIMENT

Hereinafter, a scheduling device according to one embodiment of the present invention will be explained with reference to the drawings.

FIG. 1 is a diagram illustrating an overview of a scheduling system comprising the scheduling device according to the same embodiment.

The scheduling system 100 illustrated in FIG. 1 is one example of an optimization system. The scheduling system 100 is configured by communicably connecting a scheduling device 1, which is one example of an optimization device, with a terminal 2. The terminal 2 outputs input information from a worker to the scheduling device 1. The scheduling device 1, based on the input information indicating the instructions from the worker, automatically generates schedule data for a scheduling target similar to that of a worker who is an expert in scheduling work. In the present embodiment, schedule data defining broadcasting times for advertisement broadcasts that are scheduling targets, which are an example of optimization targets, is automatically generated.

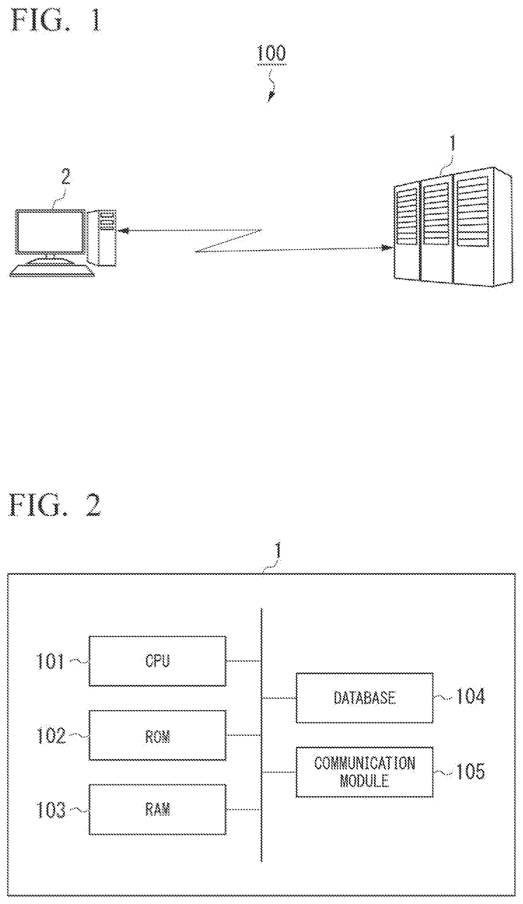

FIG. 2 is a diagram illustrating the hardware configuration of the scheduling device 1.

As illustrated in this diagram, the scheduling device 1 is a computer comprising various types of hardware such as a CPU (Central Processing Unit) 101, a ROM (Read-Only Memory) 102, a RAM (Random Access Memory) 103, a database 104, and a communication module 105. The terminal 2 is also a computer comprising similar hardware.

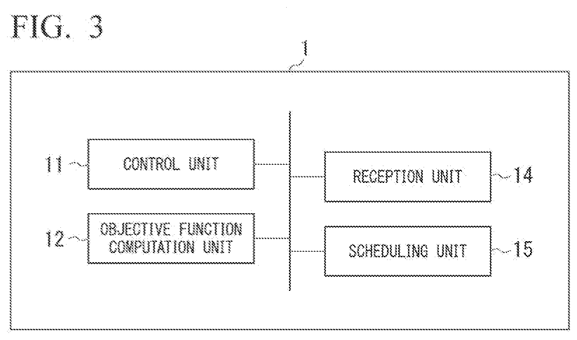

FIG. 3 is a functional block diagram of the scheduling device.

A CPU 101 in the scheduling device 1 is started when the power is switched on, and executes a pre-stored scheduling program. As a result thereof, the scheduling device 1 activates the functions of the control unit 11, the objective function computation unit 12, the reception unit 14, and the scheduling unit 15.

The control unit 11 controls the other functions of the scheduling device 1.

The objective function computation unit 12 uses optimized results (decided schedule data) by an expert who has performed optimization relating to the scheduling target in the past, a constraint parameter, and an inverse optimization technique to compute an objective function J(x) needed for scheduling the scheduling target.

The reception unit 14 receives inputs of information such as a constraint parameter associated with a constraint required for optimizing the scheduling of the scheduling target that is the optimization target.

The scheduling unit 15, which is an example of an optimization unit, generates schedule data in which the scheduling of the scheduling target is optimized on the basis of the objective function J(x).

In the present embodiment, the scheduling target is an advertisement broadcast, and the schedule data indicates a schedule for television program broadcasts and advertisement broadcasts. In such a case, the objective function computation unit 12 may compute an objective function J(x) for each advertisement broadcast. Additionally, the objective function computation unit 12 may compute an objective function J(x) and a constraint condition separately by groups determined based on the characteristics of the advertisement broadcast.

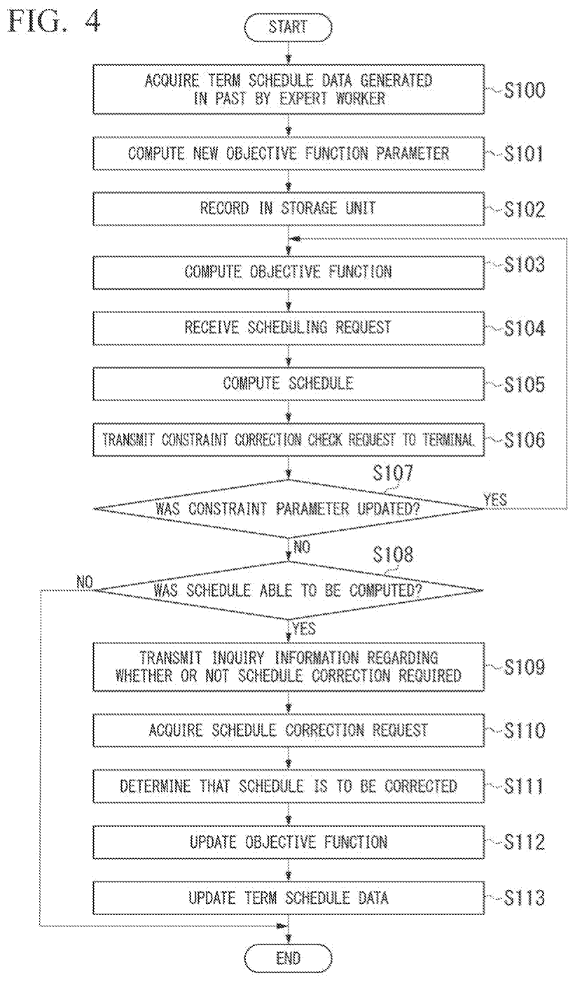

FIG. 4 is a first diagram illustrating the processing flow in a scheduling device according to the present embodiment.

Next, the processing flow in the scheduling device 1 according to the present embodiment will be explained.

The database 104 in the scheduling device 1 stores schedule data (optimized results by an expert) generated in the past by a worker such as an expert worker. The objective function computation unit 12 acquires process starting instruction information. The process starting instruction information may be input by a worker using the terminal 2 and received by the reception unit 14 of the scheduling device 1 via a communication network. Alternatively, a worker may use an input device provided in the scheduling device 1 to directly input the process starting instruction information to the scheduling device 1.

Based on acquisition of the instruction information, the objective function computation unit 12 acquires, from the database 104, term schedule data Xe={x1, x2, x3, . . . , xM} that has been generated in the past by a worker such as an expert worker (step S100). The term schedule data Xe includes at least advertisement schedules x (x1, x2, x3, . . . , xM) for respective advertisement broadcasts. The objective function computation unit 12 may acquire, one by one and in order, the advertisement schedule x for each advertisement broadcast included in the term schedule data Xe generated in the past by the expert worker. The term schedule data Xe={x1, x2, x3, . . . , xM} generated in the past by a worker such as an expert worker includes the schedule of each advertisement broadcast assigned to a prescribed broadcasting contract term. The advertisement schedules x include information regarding the schedule of each individual advertisement broadcast and characteristic information regarding the advertisement broadcast. The term schedule data Xe may include television program information including the dates/times and characteristics of television programs in addition to the information regarding the advertisement schedules x.

In this case, it will be assumed that the term schedule data Xe that has been generated in the past by a worker such as an expert worker is a result obtained by solving the mathematical optimization below.

$$\begin{matrix}[ Expression 1 ] & \\ {max}_{x ∈ {ℝ}^{d}} {θ}^{T} φ ( x ) , s . t . x ∈ X ( p ) & ( 1 )\end{matrix}$$

In Expression (1), θ is an objective function parameter that is specific to the worker such as an expert worker, and that is a special parameter determining the scheduling technique of the worker such as an expert worker. Additionally, in the objective function J(x)=θ^{T}ϕ(x), the objective function parameter θ refers to a weighting coefficient corresponding to each explanatory variable in the objective function J(x). As one example, the objective function parameter θ includes at least a relative importance level for each settable time that is predefined regarding the advertisement broadcast that is the scheduling target. In Expression (1), only the value of the objective function parameter θ is considered to be unknown.

Additionally, in Expression (1), x represents a decision variable vector R^{d}. Additionally, in Expression (1), X(p) represents an executable region, and X(p) represents a vector including one or more constraint parameters p that serve as constraint conditions. ϕ(x) represents characteristic information and constraint conditions which are explanatory variables of the advertisement schedule x. The characteristic information includes, as one example, information such as the broadcast time (the day of the week of the broadcast, the broadcast starting time, and the broadcast ending time) of the advertisement broadcast. The characteristic information may further include information such as the age demographic and sex targeted by the advertisement broadcast, the advertisement content type, and the types of television programs to be broadcast before and after the broadcast time of the advertisement broadcast. The constraint conditions include, as one example, information such as the time slots during which an advertisement must be broadcast, the types of television programs that are to be broadcast before or after the advertisement broadcast, and the number of broadcasts in a unit term. A unit term is a term such as one week or one month. The constraint parameters p are parameters relating to each of these constraint conditions. Expression (1) means that the worker such as an expert worker has prepared an advertisement broadcast schedule x in which the value of θ^{T}ϕ(x) corresponding to the objective function J(x) is maximized.

The objective function computation unit 12 uses the schedule data Xe={x₁, x₂, x₃, . . . , x_{M}} generated in the past by the worker such as an expert worker to estimate an objective function parameter θ of the worker such as an expert worker by means of inverse optimization. More specifically, the objective function computation unit 12 performs an inverse optimization based on the maximum-likelihood method.

$$\begin{matrix}[ Expression 2 ] & \\ {θ}^{*} = {arg max}_{θ} p ( {X}_{e} \vert θ ) & ( 2 )\end{matrix}$$

An objective function parameter θ* that maximizes the likelihood p(Xe|θ), under conditions in which the term schedule data Xe generated in the past by the worker such as an expert worker is applied, is taken as the parameter of the worker such as an expert worker. More specifically, this objective function parameter θ* includes weighting coefficients for each of the explanatory variables (such as the characteristic information and the constraint conditions) such as the relative importance levels of settable times set in a unit term for performing a schedule. The settable times indicate, for example, the time periods, from the broadcast starting times to the broadcast ending times, assigned to each television program, and is preset within the time from 0 o'clock to 24 o'clock on each day within the unit term. The likelihood p(Xe|θ) is obtained, for example, by using the following Expression (3).

$$\begin{matrix}[ Expression 3 ] & \\ p ( {x}_{i} \vert θ ) = \frac{exp {θ}^{T} Φ ( {x}_{i} )}{{\sum }_{{x}_{i} ∈ X} exp {θ}^{T} Φ ( {x}_{i} )} & ( 3 )\end{matrix}$$

By taking the logarithm under the assumption that the term schedule data Xe={x₁, x₂, x₃, . . . , x_{M}} generated in the past by the worker such as an expert worker is generated from independent and identical distributions, Expression (2) can be converted to the following Expression (4).

$$\begin{matrix}[ Expression 4 ] & \\ {θ}^{*} = {arg max}_{θ} ( {\sum }_{i = 1}^{M} log p ( {x}_{i} \vert θ ) ) & ( 4 )\end{matrix}$$

The objective function computation unit 12 uses the steepest ascent method to compute a new objective function parameter θ^{new} in which the objective function parameter θ* is updated (step S101). The objective function computation unit 12 records, in a storage unit such as the database 104, an ID of the advertisement broadcast that is the scheduling target, an ID indicating an explanatory variable, and the new objective function parameter θ^{new} computed for the explanatory variable, so as to be associated with each other (step S102).

$$\begin{matrix}[ Expression 5 ] & \\ {θ}^{new} = {θ}^{old} + α \frac{θ}{\partial θ} log p ( {x}_{i} \vert θ ) & ( 5 )\end{matrix}$$

The objective function computation unit 12 can determine a to be an arbitrary value in terms of step size. Additionally, in the case in which Expression (3) is employed as the expression representing the likelihood p, the objective function computation unit 12 updates the new objective function parameter θ^{new} as in the following Expression (6).

[Expression 6]

θ^{new}=θ^{old}+α(Φ(xᵢ)−Φ(x)) (6)

In the above Expression (6), ϕ(xᵢ) is a characteristic quantity extracted from the advertisement schedule x of the advertisement broadcast being processed in the term schedule data Xe generated in the past by the worker such as an expert worker. Additionally, ϕ(x) is a characteristic quantity (weighting coefficient) of the advertisement schedule x generated under the old objective function parameter θ^{old}. The objective function computation unit 12 may separately acquire, in order, the advertisement schedule x of each advertisement broadcast included in the term schedule data Xe generated in the past by the expert worker, and in this case, with each acquisition, the objective function parameter θ^{new} specific to the worker such as an expert worker is sequentially updated by the above-mentioned process. Furthermore, the objective function computation unit 12 computes the objective function J(x)=θ^{T}ϕ(x) including the objective function parameter θ^{new} for all advertisement broadcasts included in the term schedule data Xe generated in the past by the worker such as an expert worker (step S103).

In this state, a new worker uses the terminal 2 to schedule a new advertisement broadcast. At this time, due to operations by the worker, the terminal 2 communicably connects with the scheduling device 1. Additionally, due to operations by the worker, the terminal 2 outputs a scheduling request including commercial data relating to the advertisement broadcast to the scheduling device 1. The commercial data includes characteristic information and constraint conditions relating to the advertisement broadcast. As mentioned above, the characteristic information includes information such as the age demographic and sex targeted by the advertisement broadcast, the day of the week on which the advertisement is to be broadcast, the advertisement content type, and the types of television programs to be broadcast before and after the broadcast time of the advertisement broadcast. The constraint conditions may be time slots during which the advertisement must be broadcast, the types of television programs to be broadcast before or after the advertisement broadcast, or the like. Constraint conditions may be pre-stored in the scheduling device 1, and these constraint conditions may be used.

The reception unit 14 in the scheduling device 1 receives the scheduling request from the terminal 2 (step S104). The scheduling request includes commercial data and attributes (attributes relating to IDs or commercials, characteristic information, constraint conditions, etc.) relating to the commercial data. The scheduling unit 15 in the scheduling device 1 acquires the commercial data included in the received scheduling request. The scheduling unit 15 acquires characteristic information and constraint conditions for the advertisement broadcast from the commercial data. The scheduling unit 15 acquires the objective function J(x) computed by the objective function computation unit 12. The scheduling unit 15 inputs, to the objective function J(x), the characteristic information and the constraint conditions, and overall schedule data (schedule) including the term during which the advertisement broadcast is to be scheduled, advertisement broadcasts that are already set for that term, and the dates and times of the advertisement broadcasts (Expression (7)).

$$\begin{matrix}[ Expression 7 ] & \\ {max}_{( schedule )} J ( schedule , θ ) & ( 7 )\end{matrix}$$

The scheduling unit 15, as a result thereof, computes the optimal schedule for the advertisement broadcast corresponding to the commercial data included in the scheduling request (step S105). The schedule includes at least information regarding the dates and times of the advertisement broadcast.

The reception unit 14 may, in the case in which the schedule cannot be computed, receive corrections to the constraint conditions or the characteristic information included in the commercial data for the commercial broadcast. Alternatively, the reception unit 14 may receive corrections to the objective function parameter θ. For example, the reception unit 14 transmits a constraint correction check request including the computed schedule data to the terminal 2 (step S106).

The worker using the terminal 2 checks the schedule data computed for the advertisement broadcast, and determines whether the dates and times thereof represent times that are already filled by other advertisement broadcasts. Furthermore, the worker updates a parameter (constraint parameter p) such as characteristic information or a constraint condition included in the commercial data, and makes another scheduling request. Then, the terminal 2 transmits, to the scheduling device 1, a scheduling request in which the parameter has been updated.

The scheduling device 1 receives the scheduling request. The reception unit 14 in the scheduling device 1 outputs the scheduling request to the scheduling unit 15. The scheduling unit 15 determines whether or not the constraint parameter p has been updated (step S107). For example, if the scheduling request includes a constraint parameter p, then the scheduling unit 15 determines that the constraint parameter p has been updated by the user. In the case in which the constraint parameter p has been updated, the scheduling device 1 repeats the process of computation of the objective function in step S103 described above.

The scheduling unit 15 may automatically determine whether the schedule data computed regarding the advertisement broadcast includes a time that has already been filled by another advertisement broadcast. In that case, the scheduling unit 15 updates the constraint parameter p such as the characteristic information or the constraint condition included in the commercial data by means of a defined update process, and repeats the schedule computation process. Furthermore, the scheduling unit 15 determines whether the advertisement broadcast request specified by the scheduling request was able to be computed (step S108). In cases such as the case in which the advertisement broadcast schedule cannot be computed even when the constraint parameter p is updated a prescribed number of times, the case in which there is not a time to which the advertisement broadcast can be assigned among the empty times in the schedule data overall, or the case in which a termination request has been received from the terminal 2 based on an operation by the worker, the scheduling unit 15 determines that a schedule cannot be computed, and the process ends.

In the case in which the advertisement broadcast schedule specified by the scheduling request is determined to be computable, the scheduling unit 15 determines whether or not to correct the schedule. For example, the scheduling unit 15 instructs the reception unit 14 to transmit, to the terminal 2, inquiry information regarding whether or not schedule correction is required. The reception unit 14 transmits, to the terminal 2, the inquiry information regarding whether or not schedule correction is required (step S109). The inquiry information may include data regarding the computed schedule or information for a schedule correction screen.

The terminal 2 outputs the schedule data to a monitor or the like. The worker checks the schedule data content and determines whether or not to make a correction. In the case in which the schedule is to be corrected, the worker inputs the correction information to the terminal 2. The worker making the correction is assumed to be a worker such as an expert worker. The correction information includes a date and time indicating a schedule that has not yet been decided or the like. Then, based on the operations by the worker, the terminal 2 transmits, to the scheduling device 1, a schedule correction request including the corrected schedule data or the like.

The reception unit 14 acquires the schedule correction request (step S110). The reception unit 14 outputs the corrected schedule data included in the schedule correction request to the scheduling unit 15. In the case in which corrected schedule data has been received, the scheduling unit 15 determines that the schedule is to be corrected (step S111). Then, the scheduling unit 15 starts updating the objective function. As with the process in step S102, the scheduling unit 15 uses the corrected schedule data to compute the objective function including the parameters θ^{new}, and updates the objective function (step S112).

Then, the scheduling unit 15 computes the optimal schedule for the advertisement broadcast corresponding to the commercial data that is the scheduling target based on the updated objective function, and updates the overall term schedule data indicating the schedules for multiple advertisement broadcasts and television programs, including the schedule data that has been computed (step S113).

Due to the above processes, the scheduling device 1 computes an objective function to be used for generating schedule data for the scheduling target based on the characteristics of the scheduling target and schedule data that has already been decided regarding the scheduling target. At this time, the scheduling device 1 uses the inverse optimization technique based on decided schedule data that has been generated in the past to compute the objective function including a parameter specific to the scheduling method of a worker (such as an expert worker) who generated the decided schedule data. Furthermore, the scheduling device 1 generates schedule data for a scheduling target with an undecided schedule by using the characteristics of the scheduling target with the undecided schedule and the objective function.

Due to such processes, the scheduling device 1 can provide a scheduling device for automatically generating schedule data similar to that of a worker (such as an expert worker) who generated the decided schedule data.

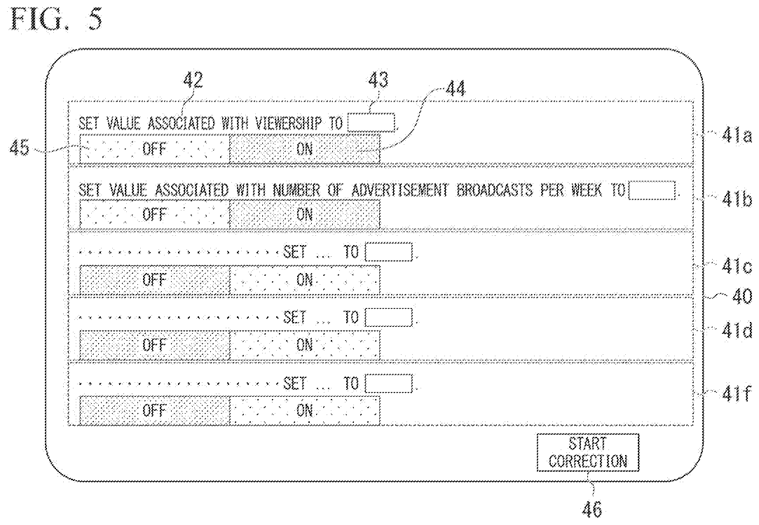

FIG. 5 is a diagram illustrating a constraint correction check screen.

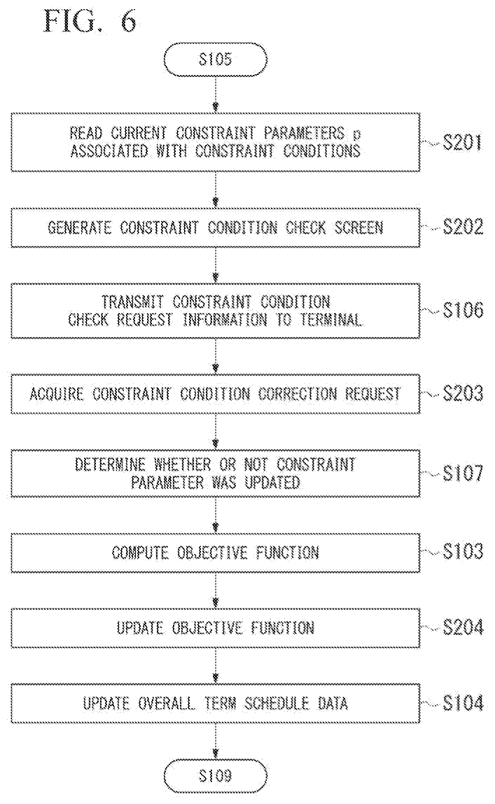

FIG. 6 is a second diagram illustrating the processing flow in the scheduling device according to the present embodiment.

The constraint correction check request transmitted in step S106 in the process described above includes data for a constraint correction check screen 40 generated by the scheduling device 1. In the constraint correction check screen 40, as illustrated in FIG. 5, change instruction windows 41 for constraint parameters associated with constraint conditions that can be changed among the constraint parameters for advertisement broadcasts are provided for multiple constraint conditions.

The constraint correction check screen 40 in FIG. 5 indicates an embodiment in which change instruction windows 41a to 41f are provided for constraint parameters associated with five constraint conditions from a first constraint condition to a fifth constraint condition. The change instruction windows 41a to 41f will be referred to collectively as change instruction windows 41. Each change instruction window displays constraint condition description text 42, a numerical value change box 43 for a constraint parameter p, and an activation button (ON) 44 and a deactivation button (OFF) 45 for the constraint condition. Additionally, the constraint correction check screen 40 provides a button image 46 for the user to instruct the scheduling device 1 to start the correction.

In the example of the constraint correction check screen 40 in FIG. 5, a change instruction window 41a is provided for a constraint parameter associated with viewership, as a first constraint condition. Additionally, in the example of the constraint correction check screen 40, a change instruction window 41b is provided for a constraint parameter associated with a number of advertisement broadcasts in a contract term, as a second constraint condition. Aside therefrom, a change instruction window 41c for a constraint parameter associated with a third constraint condition, a change instruction window 41d for a constraint parameter associated with a fourth constraint condition and a change instruction window 41f for a constraint parameter associated with a fifth constraint condition are similarly provided.

As processes before or after transmitting the constraint correction check request in step S106 described above, the reception unit 14 reads changeable constraint conditions stored in the database 104 so as to be linked with the ID of an advertisement broadcast that is a scheduling target, and the current constraint parameters p associated with those constraint conditions (step S201). The reception unit 14 uses the constraint conditions that have been read and the respective constraint parameters p to generate a constraint correction check screen 40 indicating the above-mentioned change instruction windows 41 (step S202). The reception unit 14 transmits, to the terminal 2, constraint condition check request information including at least the computed schedule data and the constraint correction check screen 40 (step S106).

The terminal 2 receives the constraint condition check request information. The terminal 2 displays, on a display, the constraint correction check screen 40 included in the information, and schedule data. The schedule data, in one example, indicates a television program schedule in which respective settable times are designated in a unit term, and the times for which advertisement broadcasts have been set in that television program schedule. A worker, who is the user, checks the schedule data, and in the case in which the worker wishes to change a constraint condition to be applied to the scheduling of the advertisement broadcast, the worker uses an input device such as a tenkey pad or a mouse to change the value in a numerical value change box 43 for a constraint parameter p included in the change instruction window 41 of each constraint condition indicated on the constraint correction check screen 40. For example, the value of the constraint parameter p associated with viewership, which is the first constraint condition, is changed. Alternatively, the value of the constraint parameter p associated with the number of advertisement broadcasts, which is the second constraint condition, is changed.

Alternatively, the worker, who is the user, can set whether to activate or deactivate each of the control conditions, from the first constraint condition to the fifth constraint condition, when computing the objective function. For example, in the change instruction window 41 for any of the constraint conditions from the first constraint condition to the fifth constraint condition, that constraint condition can be activated by pressing the activation button (ON) 44, and that constraint condition can be deactivated by pressing the deactivation button (OFF) 45.

By making such changes, the scheduling device 1 can compute an objective function for optimizing the scheduling in which constraint conditions in accordance with the desires of a user are reflected by changing the values of the constraint parameters p.

The user operates a mouse or the like to press the button image 46 for starting correction. Then, in the case in which a value in a numerical value change box has been changed, the terminal 2 transmits a constraint condition correction request including at least the ID of the advertisement broadcast that is to be the scheduling target, and the ID of the constraint condition that the user changed in the constraint correction check screen 40 and the value of the constraint parameter p after the change. Additionally, if an activation button 44 or a deactivation button 45 is pressed, then the terminal 2 transmits, to the scheduling device 1, a constraint condition correction request including the ID of that constraint condition and an activation flag indicating activation of the constraint condition or a deactivation flag indicating deactivation.

The reception unit 14 of the scheduling device 1 acquires the constraint condition correction request (step S203). The reception unit 14 acquires the values of the advertisement broadcast IDs, the constraint condition IDs, the changed constraint parameters p and the button IDs included in the constraint condition correction request, and outputs these values to the scheduling unit 15. The scheduling unit 15 identifies the constraint conditions to be changed based on the constraint condition IDs that were acquired, and the combination of the constraint condition IDs with the activation flags or deactivation flags. The scheduling unit 15 determines whether or not the constraint parameters have been updated based on the identification of the constraint conditions to be changed (step S107).

More specifically, if the constraint condition correction request includes a constraint condition ID and a deactivation flag, the reception unit 14 identifies that constraint condition as a constraint condition that is to be changed to be deactivated for computation of the objective function. Additionally, if the constraint condition correction request includes a constraint condition ID and an activation flag, the reception unit 14 identifies that constraint condition as a constraint condition that is to be changed to be activated for computation of the objective function. Additionally, if the constraint condition correction request includes a constraint condition ID, an activation flag and the value of a changed constraint parameter p, the reception unit 14 identifies the constraint parameter p associated with that constraint condition as the constraint condition to be changed to the changed constraint parameter p. In the case in which a constraint condition to be changed has been identified, the scheduling unit 15 determines that a constraint parameter has been updated.

The scheduling unit 15 computes an objective function in which the constraint parameter p associated with the identified constraint condition has been changed to the changed constraint parameter p, or computes an objective function in which the constraint parameter p associated with the identified constraint condition has been activated or deactivated (step S103). The scheduling unit 15 stores, in a storage unit such as the database 104, the ID of the user, the ID of the advertisement broadcast, the objective function, the ID of the changed constraint condition and the value of the constraint parameter p thereof, so as to be linked with each other. As a result thereof, the scheduling device 1 updates the objective function (step S204).

Then, the scheduling unit 15 computes the optimal schedule for the advertisement broadcast corresponding to the commercial data that is the scheduling target based on the updated objective function (step S205). Then, the scheduling unit 15 determines whether a schedule was able to be computed for the advertisement broadcast that is identified by the scheduling request (step S108). Thereafter, the process shifts to step S109.

According to the process described above, the user can freely change the value of a constraint parameter p, and whether to activate or deactivate that constraint parameter. Therefore, a system can be provided that allow an optimization target to be optimized in accordance with the desires of a user by using an objective function newly reflecting the desires of the user regarding constraints on the optimization process of the optimization target.

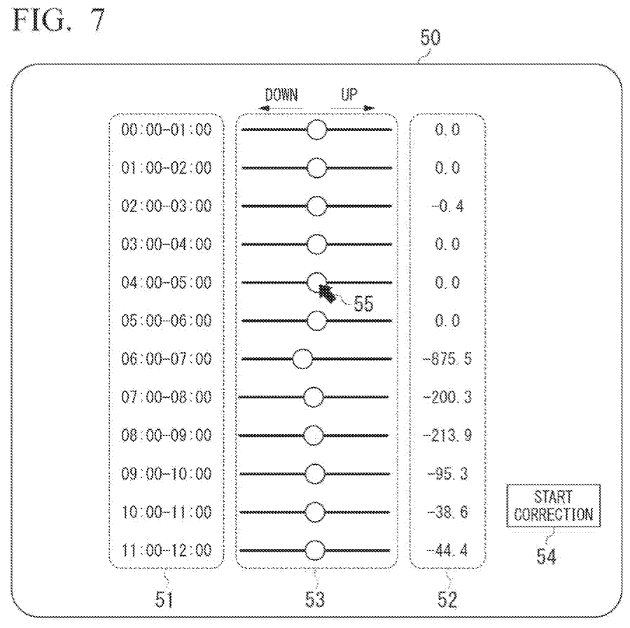

FIG. 7 is a diagram illustrating a schedule correction screen.

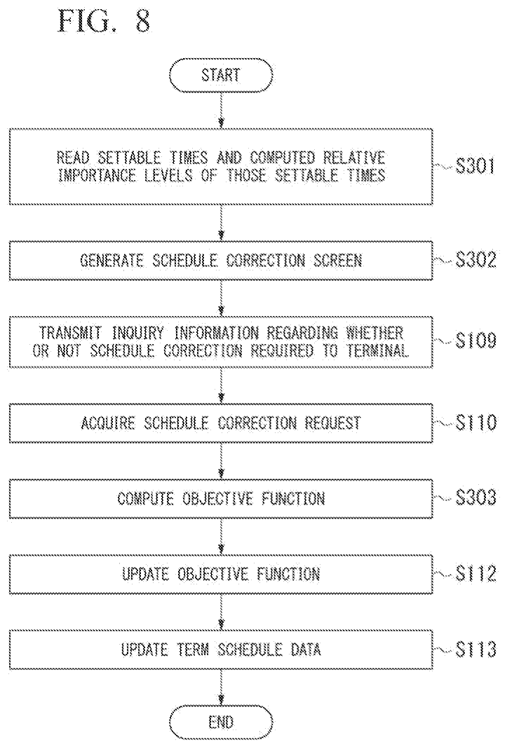

FIG. 8 is a third diagram illustrating the processing flow in the scheduling device according to the present embodiment.

Aside from the constraint parameters p relating to the constraint conditions, the user may also be able to correct the objective function parameter θ. In this case, when transmitting the inquiry information regarding whether or not schedule correction is required in step S109 in the process mentioned above, the scheduling device 1 transmits, to the terminal 2, the inquiry information regarding whether or not schedule correction is required so as to include data for a schedule correction screen 50.

The schedule correction screen 50, as illustrated in FIG. 7, provides a first display area 51 for displaying multiple settable times, which are one of the constraint parameters for advertisement broadcasts. Additionally, the schedule correction screen 50 provides a second display area 52 for displaying the relative importance level (objective function parameter Anew) of each of the settable times for the advertisement broadcasts. Additionally, the schedule correction screen 50 is provided with a third display area 53 for displaying indicators for changing relative importance levels. Additionally, the schedule correction screen 50 is provided with a button image 54 for the user to instruct the scheduling device 1 to start correction.

As a process before or after transmitting inquiry information regarding whether or not schedule correction is required in step S109 described above, the reception unit 14 reads the settable times stored in the database 104 so as to be linked with the ID of the advertisement broadcast that is the scheduling target, and the relative importance levels (objective function parameters θ^{new}) computed for those settable times (step S301). The reception unit 14 generates a schedule correction screen 50 displaying the settable times that have been read, the relative importance levels computed for those settable times, and indicators for changing the relative importance levels (step S302). The reception unit 14 transmits, to the terminal 2, the inquiry information regarding whether or not schedule correction is required, including the schedule correction screen 50 (step S109).

The terminal 2 receives the inquiry information regarding whether or not schedule correction is required. The terminal 2 displays, on a display, the schedule correction screen 50 included in the information, and schedule data. As mentioned above, the schedule data, in one example, indicates a television program schedule in which respective settable times are designated in a unit term, and the times for which advertisement broadcasts have been set in the television program schedule. A worker, who is the user, checks the schedule data, and in the case in which the worker wishes to change the value of the relative importance level with respect to any of the settable times to be applied to advertisement broadcast scheduling, the worker uses an input device such as a tenkey pad or a mouse to move the positions of the indicators in the third display area on the schedule correction screen 50 with a cursor 55 by means of dragging operations.

In the present embodiment, when the user moves an indicator to the left, the relative importance level value for the settable time being manipulated goes down. Additionally, when the user moves an indicator to the right, the relative importance level value for the settable time being manipulated goes up. In FIG. 7, the settable times in which the relative importance level value is negative and the absolute value thereof is a high value indicate that the importance as a set time for optimization of scheduling of the advertisement broadcast that is the scheduling target is higher than the importance as a schedule-setting time relative to other settable times.

In the case in which the position of the indicator is set at the center in the left-right direction, the value of the relative importance level becomes “0”. A settable time in which the value of the relative importance level is “0” means that the importance as a schedule-setting time for the advertisement broadcast that is the scheduling target is a central value. The user can set the value of the relative importance level to be positive by moving the position of the indicator to the right.

Due to these settings, during scheduling optimization, the scheduling device 1 computes an objective function in which the settable times that have been set to high relative importance levels have a higher probability of being assigned the advertisement that is the scheduling target, or in which the settable times that have been set to low relative importance levels have a lower probability of being assigned the advertisement that is the scheduling target.

The user manipulates a mouse or the like to press the button image 54 for starting the correction. Then, the terminal 2 transmits a schedule correction request including at least IDs indicating settable times designated as those to be changed by changing the positions of indicators on the schedule correction screen 50, the values of the relative importance levels changed by the user for those settable times, and the ID of the advertisement broadcast.

The reception unit 14 in the scheduling device 1 acquires the schedule correction request (step S110). The reception unit 14 outputs, to the scheduling unit 15, the advertisement broadcast ID, the IDs indicating the settable times, and the changed relative importance level values included in the schedule correction request. The scheduling unit 15 uses the IDs indicating the settable times and the values of the relative importance levels (parameters Anew) changed by the user for those settable times to compute the objective function (step S303). The scheduling unit 15 stores, in the storage unit, the ID of the user, the ID of the advertisement broadcast, the objective function, the IDs indicating the settable times, and the corrected relative importance level values in those settable times, so as to be linked with each other. As a result thereof, the scheduling device 1 updates the objective function (step S112).

Then, the scheduling unit 15 computes the optimal schedule for the advertisement broadcast corresponding to the commercial data that is the scheduling target based on the updated objective function, and updates the overall term schedule data indicating the schedules for multiple advertisement broadcasts and television programs, including the schedule data that has been computed (step S113).

According to the above-mentioned process, the user can assign broadcasting times of advertisement broadcasts to more appropriate settable times simply by using the schedule correction screen automatically output by the scheduling device 1 to change the relative importance levels, relative to other settable times, of settable times for the advertisement broadcast that is the scheduling target.

Additionally, according to the above-mentioned process, the scheduling device 1 outputs, to the terminal 2, a schedule correction screen 50 clearly indicating that the objective parameters in the objective function are relative importance levels. Thus, the user can easily change the relative importance levels to attempt to assign broadcast times of the advertisement broadcast to settable times that are more appropriate.

Additionally, according to the above-mentioned process, the user can immediately check the results of scheduling performed by the scheduling device 1 to check whether the advertisement broadcast has been assigned to settable times that are appropriate.

The above-mentioned scheduling device 1 represents an example of a case in which advertisement broadcasts are scheduled into settable times. However, by processes similar to the above-mentioned processes, the scheduling device 1 may be applied to the case in which places to be visited by a user on business are to be scheduled into times in which visits are possible. In this case, the characteristics of the places to be visited may be addresses to be visited and distances to the places to be visited, and the constraint conditions may be the difficulty of work or time required for work at the places to be visited, or the like. Additionally, the objective function parameters may be the relative importance levels when assigning work to the times in which visits are possible. Additionally, the scheduling device 1 may compute the objective function or compute schedule data by the above-mentioned processes separately for each scheduling target.

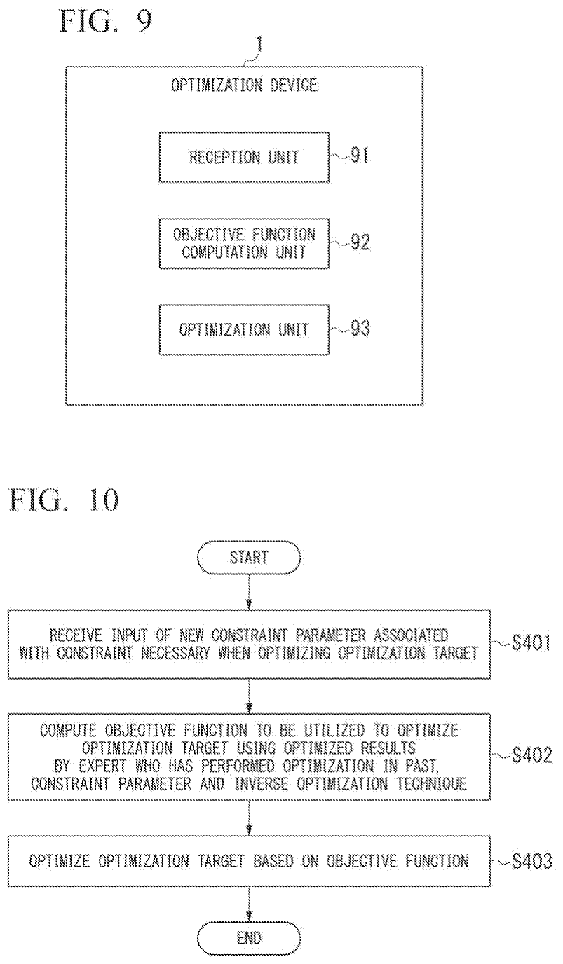

FIG. 9 is a diagram illustrating the minimum configuration of the scheduling device.

FIG. 10 is a diagram illustrating the processing flow in the scheduling device having the minimum configuration.

As illustrated in FIG. 9, the scheduling device provides the functions of at least a reception unit 91, an objective function computation unit 92 and an optimization unit 93.

The reception unit 91 receives an input of a constraint parameter associated with a constraint required when optimizing an optimization target (step S401).

The objective function computation unit 92 computes an objective function to be utilized to optimize the optimization target using optimized results by an expert who has performed the optimization in the past, a constraint parameter and an inverse optimization technique (step S402).

The optimization unit 93 optimizes the optimization target based on the objective function (step S403).

In the embodiment described above, the reception unit 91 receives an input of a constraint parameter associated with a constraint required for optimizing the scheduling of a scheduling target, which is the optimization target.

Additionally, the objective function computation unit 92 computes the objective function utilized for scheduling the scheduling target by using schedule data which are optimized results by an expert who has performed the optimization in the past, the received constraint parameter, and an inverse optimization technique.

Additionally, the optimization unit 93 generates schedule data in which the scheduling of the scheduling target has been optimized based on the objective function.

In the embodiment described above, the optimization target is an advertisement broadcast, and the case in which the scheduling of advertisement broadcasts is optimized is described. However, the scheduling device 1 may be a device for optimizing another optimization target.

For example, the optimization target may be the steering wheel of a car, and the optimization process may control the angle of the steering wheel of the car from a prescribed position. In this case, the objective function may be for scheduling the angles of the steering wheel at moments in time up to a few minutes in the future. Furthermore, in this case, the reception unit 91 receives an input of a constraint parameter associated with a constraint required for optimizing the scheduling of the angle of the steering wheel, which is the optimization target. The objective function computation unit 92 computes the objective function to be utilized for scheduling the angles of the steering wheel at moments in time up to a few minutes in the future by using chronological steering wheel angle data indicated by driving results by an expert driver, the received constraint parameter, and an inverse optimization technique. The optimization unit 93 generates schedule data indicating the angles of the steering wheel at the respective moments in time up to a few minutes in the future based on the objective function.

Additionally, the optimization target may be the accelerator of a car, and the optimization process may control the degree of depression of the accelerator of the car. In this case, the objective function may be for scheduling the degrees of depression of the accelerator at moments in time up to a few minutes in the future. Furthermore, in this case, the reception unit 91 receives an input of a constraint parameter associated with a constraint required for optimizing the scheduling of the degree of depression (amount of depression) of the accelerator, which is the optimization target. The objective function computation unit 92 computes the objective function to be utilized for scheduling the degrees of depression of the accelerator at moments in time up to a few minutes in the future by using chronological accelerator depression degree data indicated by driving results by an expert driver, the received constraint parameter, and an inverse optimization technique. The optimization unit 93 generates schedule data indicating the degrees of depression of the accelerator at the respective moments in time up to a few minutes in the future based on the objective function.

Additionally, the optimization target may be a product, and the optimization process may compute the amount of the product to be ordered. In this case, the objective function may be for scheduling the amount of the product to be ordered on each day in the future. Furthermore, in this case, the reception unit 91 receives an input of a constraint parameter associated with a constraint required for optimizing the amounts of a product ordered, which is the optimization target. The objective function computation unit 92 computes the objective function to be utilized for computing the amounts of the product to be ordered on each day in the future by using the amounts ordered on similar days in the past indicated by order results by an expert, the received constraint parameter, and an inverse optimization technique. The optimization unit 93 generates schedule data indicating the amounts of the product to be ordered on each day in the future based on the objective function.

The above-mentioned scheduling device 1 may have a computer system that is internal thereto. Furthermore, the steps in the above-mentioned processes are stored in the form of a program in a computer-readable storage medium, and the above-described process is performed by a computer reading out and executing this program. In this case, the computer-readable recording medium refers to a magnetic disk, a magneto-optic disk, a CD-ROM, a DVD-ROM, a semiconductor memory, or the like. Additionally, this computer program may be transmitted to the computer by means of communication lines, and the computer that has received this transmission may execute the program.

The above-described program may be for realizing just some of the aforementioned functions. Furthermore, it may be a so-called difference file (difference program) in which the aforementioned functions can be realized by being combined with a program that is already recorded on the computer system.

### REFERENCE SYMBOLS

1 Scheduling device (optimization device)
2 Terminal
11 Control unit
12 Objective function computation unit (objective function computation means)
14 Reception unit (reception means)
15 Scheduling unit (optimization means)
100 Scheduling system

What is claimed is:

1. An optimization device comprising:
at least one memory configured to store instructions; and
at least one processor configured to execute the instructions to:
receive an input of a constraint parameter associated with a constraint required when optimizing a target;
compute an objective function to be utilized for the optimization of the target by using optimized results by an expert who has performed the optimization in the past, the constraint parameter, and an inverse optimization technique; and
optimize the target based on the objective function.

2. The optimization device according to claim 1, wherein the at least one processor is configured to execute the instructions to:
receive an input of a constraint parameter associated with a constraint required for optimizing scheduling of a scheduling target, which is the target;
compute the objective function to be utilized for the scheduling of the scheduling target based on the constraint parameter; and
generate schedule data obtained by optimizing scheduling of the scheduling target based on the objective function.

3. The optimization device according to claim 2, wherein the at least one processor is configured to execute the instructions to:
compute the objective function based on the constraint parameter and the schedule data that has been decided regarding the scheduling target.

4. The optimization device according to claim 3, wherein the at least one processor is configured to execute the instructions to:
use the inverse optimization technique based on schedule data that has been generated in the past to compute the objective function including a parameter specific to a scheduling technique of a worker who generated the schedule data that has been decided.

5. The optimization device according to claim 3, wherein the at least one processor is configured to execute the instructions to:
compute the objective function for each scheduling target.

6. The optimization device according to claim 2, wherein
the scheduling target is an advertisement broadcast,
the schedule data is a schedule for broadcasts of the scheduling target, and
the at least one processor is configured to execute the instructions to generate the schedule data for the advertisement broadcast.

7. The optimization device according to claim 6, wherein:
the constraint parameter is a value associated with viewership or a number of broadcasts of the advertisement broadcast.

8. An optimization method comprising:
receiving an input of a constraint parameter associated with a constraint required when optimizing a target;
computing an objective function to be utilized for the optimization of the target by using optimized results by an expert who has performed the optimization in the past, the constraint parameter, and an inverse optimization technique; and
optimizing the target based on the objective function.

9. A non-transitory computer-readable recording medium that stores a program that causes a computer in an optimization device to perform processes, the process comprising:
receiving an input of a constraint parameter associated with a constraint required when optimizing a target;
computing an objective function to be utilized for the optimization of the target by using optimized results by an expert who has performed the optimization in the past, the constraint parameter, and an inverse optimization technique; and
optimizing the target based on the objective function.
